(19) United States
(12) Patent Application Publication
(10) Pub. No.: US 2012/0260010 A1
(43) Pub. Date: Oct. 11, 2012

(54) Storage control system and storage control method

(75) Inventors: Zhengxian Zou, Chengdu (CN); Fei Xu, Chengdu (CN)

(73) Assignee: IPGoal Microelectronics (SiChuan) Co., Ltd.

(21) Appl. No.: 13/250,840

(22) Filed: Sep. 30, 2011

(30) Foreign Application Priority Data
Oct. 27, 2010 (CN) 201010522877.9

(51) Int. Cl. G06F 3/00

(52) U.S. Cl. 710/52

(57) ABSTRACT

A storage control system, for controlling data transmission between a computer and an external device, includes a USB interface connected to the computer, an external interface connected to the external device and a control module connected between the USB interface and the external interface. The control module includes a data transmission submodule transmitting data with the computer, a microcontroller controlling a work flow of the control module, a ROM connected to the microcontroller, a protocol resolution submodule resolving data, a protocol timing sequencer connected to the external interface for transforming protocols and a buffer connected between the protocol resolution submodule and the protocol timing sequencer for storing data. The ROM changes its code according to different external devices. The microcontroller controls a work flow of the control module according to the code of the ROM to realize functions of different external devices. The invention further provides a storage control method.

### BACKGROUND OF THE PRESENT INVENTION

1. Field of Invention

The present invention relates to a control system and a control method, and more particularly to a storage control system having a storage function of a USB (universal serial bus) flash drive (U disk) and an information-reading function of a card reader, and a storage control method thereof.

2. Description of Related Arts

A U disk is a storage device based on a USB interface and having a storage medium of a flash chip. The invention of U disk is a great breakthrough in the field of portable storage technology, whose small size makes it fit for carrying about and convenient to exchange data at any time and any place, which is an ideal product for mobile office and data storage and exchange.

A card reader is a device for reading and writing information on a card, and is also a standard computer external device. The card reader has a big data storage capacity with a card inserted in, and other features of small size, low price, steady performance and convenience to carry about, and thus it is widely accepted by consumers.

The present U disks and card readers are respectively independent devices. For designers, they need to design different storage control systems to realize corresponding functions for different products, which leads to complicated designings and high costs.

### SUMMARY OF THE PRESENT INVENTION

Thus, it is necessary to provide a storage control system having a storage function of a U disk and an information-reading function of a card reader, and a storage control method thereof.

A storage control system, for controlling data transmission between a computer and an external device, comprises a USB interface connected to the computer, an external interface connected to the external device and a control module connected between the USB interface and the external interface. The control module comprises a data transmission submodule transmitting data with the computer, a microcontroller controlling a work flow of the control module, a ROM (read-only memory) connected to the microcontroller, a protocol resolution submodule for resolving data, a protocol timing sequencer connected to the external interface for transforming protocol and a buffer connected between the protocol resolution submodule and the protocol timing sequencer for storing data. A code in the ROM is changed based on different external devices. Based on the code in the ROM, the microcontroller controls the work flow of the control module to realize functions of the different external devices.

A storage control method, for controlling data transmission between a computer and an external device, comprises the following steps:

receiving data transmitted by the computer with a data transmission submodule, and transmitting the data to a protocol resolution submodule;

resolving a protocol of the received data by the protocol resolution submodule and transmitting the data to a buffer;

reading the data in the buffer by a protocol timing sequencer, transforming the data into a standard protocol and transmitting the standard protocol to the external device;

transforming the standard protocol transmitted by the external device into the data and storing the data to the buffer by the protocol timing sequencer; and

reading the data in the buffer, transforming the data to be recognizable to the computer, transmitting the data to the data transmission submodule by the protocol resolution submodule, and further transmitting the data to the computer by the data transmission submodule.

Compared to the prior art, the storage control system and the storage control method of the present invention only need changing the code of the ROM to realize the corresponding functions of different designed products. The present invention also has a simple structure and is easy to be used and in low cost.

### BRIEF DESCRIPTION OF THE DRAWINGS

FIG. 1 is a sketch view of function modules of a storage control system according to a preferred embodiment of the present invention.

FIG. 2 is a flow chart of a storage control method according to a preferred embodiment of the present invention.

### DETAILED DESCRIPTION OF THE PREFERRED EMBODIMENT

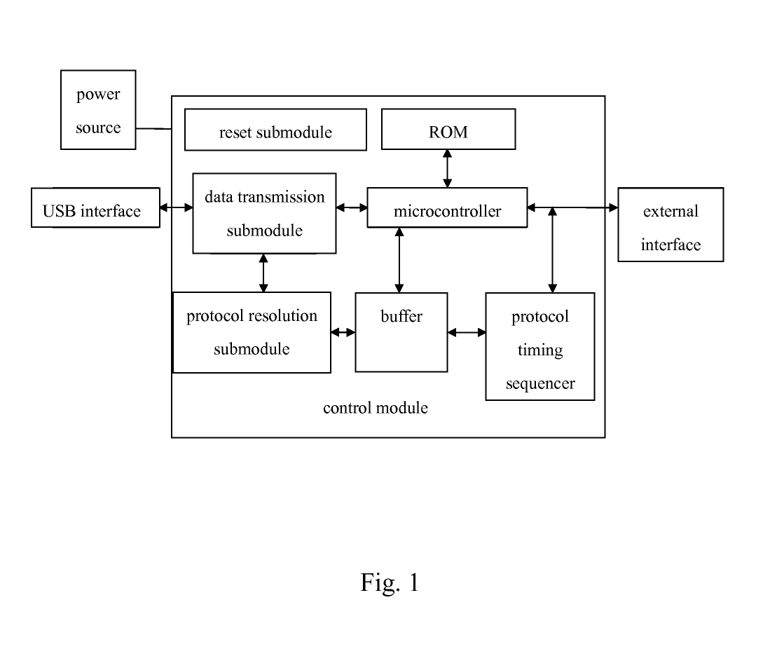

Referring to FIG. 1 of the drawings, a storage control system, according to a preferred embodiment of the present invention, comprises a power source supplying power to the storage control system, a USB interface connected to a computer, a control module connected to the USB interface and an external interface connected to the control module. The external interface is for connecting an external device, such as a flash chip and a memory card of various styles. The control module comprises a reset submodule, a data transmission submodule connected to the USB interface, a protocol resolution submodule connected to the data transmission submodule, a buffer connected to the protocol resolution submodule, a protocol timing sequencer connected to the buffer, a microcontroller respectively connected to the data transmission submodule, the buffer and the protocol timing sequencer and a ROM connected to the microcontroller. The external interface is connected to the microcontroller and the protocol timing sequencer in the control module.

According to the preferred embodiment of the present invention, the power source is a +5 volt power supply and the USB interface is a USB 2.0 full-speed interface. The reset submodule is for resetting the whole system when powering up. The data transmission submodule is able to transmit data with the computer through the USB interface, i.e., receiving transmitted data from the computer and transmitting data to the computer through the USB interface. The microcontroller controls a work flow of the whole control module according to the code in the ROM. The protocol resolution submodule is for resolving a protocol of the data received by the data transmission submodule and transforming the data in the buffer to be recognizable to the computer. The buffer is for storing the resolved data. The protocol timing sequencer is for reading the data in the buffer, transforming the data into a standard protocol, transmitting the standard protocol to the external interface, transforming the standard protocol in the external device transmitted by the external interface into the data and storing the data to the buffer. According to the preferred embodiment of the present invention, the standard protocol is an SPI (Serial Peripheral Interface) protocol.

The storage control system has the following working principles: when needing to read the data in the computer and store the data to an external device, the USB interface transmits and communicates data with the computer, the data transmission submodule receives the data transmitted by the computer and transmits the data to the protocol resolution submodule, the protocol resolution submodule protocol resolves the received data and transmits to the buffer, the protocol timing sequencer reads the data in the buffer, transform the data into the SPI protocol and transmits to the external device through the external interface; when needing to read the data in the external device and store the data to the computer, the external interface transmits and communicates with the external device, the protocol timing sequencer transforms the SPI protocol transmitted by the external interface into the data and stores the data to the buffer, the protocol resolution submodule reads the data in the buffer, transforms the data to be recognizable to the computer and transmits to the data transmission submodule, the data transmission submodule transmits the data through the USB interface to the computer. In the whole working process, the microcontroller controls and coordinates the work flow of the whole control module according to the code in the ROM.

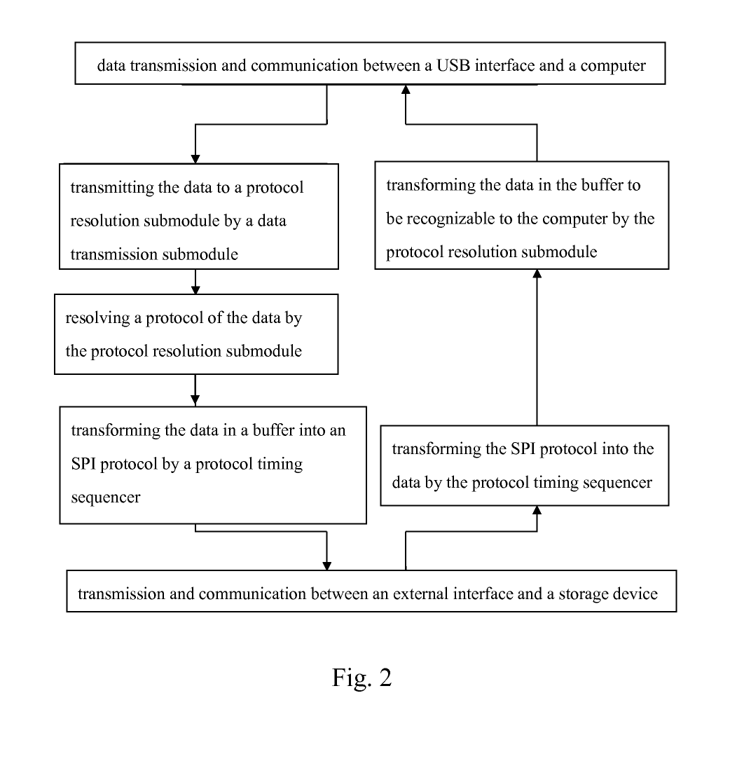

Referring to FIG. 2 of the drawings, the storage control method, according to a preferred embodiment of the present invention, comprises a process of transmitting the data in the computer to the external device and transmitting the data in the external device to the computer, comprising the following steps:

Step one: transmitting and communicating the data between the computer and the USB interface;

Step two: receiving the data transmitted by the computer and transmitting the data to the protocol resolution submodule by the data transmission submodule;

Step three: resolving a protocol of the received data by the protocol resolution submodule and transmitting to the buffer;

Step four: reading the data in the buffer by the protocol timing sequencer and transforming the data into the SPI protocol and transmitting to the external interface;

Step five: transmitting and communicating the data between the external interface and the external device;

Step six: transforming the SPI protocol transmitted by the external interface into the data and storing to the buffer by the protocol resolution submodule;

Step seven: reading the data in the buffer, transforming the data to be recognizable to the computer and transmitting to the data transmission submodule by the protocol resolution submodule, transmitting the data to the computer through the USB interface by the data transmission submodule, and then going to the Step one.

In the storage control method, designers can change the code saved in the ROM based on the different types of external devices, so as to realize the data transmission between the computer and the different external devices.

In the present invention, changing the code in the ROM can realize different functions, for example, when needing a storage function of a U disk, by connecting the external interface to the flash chip, and supposing that the code saved in the ROM is a first code, the microcontroller controls the work flow of the whole control module based on the first code to realize the storage function of the U disk; when needing an information reading function of a card reader, by connecting the external interface to the memory card and changing the saved code in the ROM to a second code, the microcontroller controls the work flow of the whole control module based on the second code, so as to realize the information reading function of the card reader; when needing a storage function of a U disk and an information reading function of a card reader simultaneously, by changing the saved code in the ROM to a third code, the micro controller controls the work flow of the whole control module based on the third code, so as to realize the storage function of the U disk and the information reading function of the card reader. Obviously, for different designed products, only changing the code of the ROM is needed, that is, using a frame of the same storage control system to realize functions of different products.

In the storage control system and the storage control method of the present invention, only changing the code of the ROM is needed to realize the corresponding functions of different designed products. The present invention also has a simple structure and is easy to be used and in low cost.

What is claimed is:

1. A storage control system, for controlling data transmission between a computer and an external device, comprising a USB interface for connecting to the computer, an external interface for connecting to the external device, a control module connected to said USB interface and said external interface, wherein said control module comprises a data transmission submodule for transmitting data with the computer, a microcontroller controlling a work flow of said control module, a ROM connected to said microcontroller, a protocol resolution submodule for resolving data, a protocol timing sequencer connected to said external interface for transforming protocol, and a buffer connected between said protocol resolution submodule and said protocol timing sequencer for storing data, wherein a code in said ROM is changed according to different external devices, and said microcontroller controls a work flow of said control module according to said code in said ROM to realize functions of different external devices.

2. The storage control system, as recited in claim 1, wherein said data transmission submodule is connected to said USB interface, and transmits data with the computer through said USB interface.

3. The storage control system, as recited in claim 1, wherein said protocol resolution submodule is connected between said data transmission submodule and said buffer, for resolving a protocol of the data received by said data transmission submodule, transmitting the data to said buffer, transforming the data in said buffer to be recognizable to the computer and transmitting the data to said data transmission submodule.

4. The storage control system, as recited in claim 2, wherein said protocol resolution submodule is connected between said data transmission submodule and said buffer, for resolving a protocol of the data received by said data transmission submodule, transmitting the data to said buffer, transforming the data in said buffer to be recognizable to the computer and transmitting the data to said data transmission submodule.

5. The storage control system, as recited in claim 1, wherein said protocol timing sequencer is connected between said buffer and said external interface, for reading data in said buffer, transforming the data into a standard protocol, transmitting said standard protocol to said external interface, transforming said standard protocol in the external device transmitted by said external interface into data and storing the data to said buffer.

6. The storage control system, as recited in claim 2, wherein said protocol timing sequencer is connected between said buffer and said external interface, for reading data in said buffer, transforming the data into a standard protocol, transmitting said standard protocol to said external interface, transforming said standard protocol in the external device transmitted by said external interface into data and storing the data to said buffer.

7. The storage control system, as recited in claim 3, wherein said protocol timing sequencer is connected between said buffer and said external interface, for reading data in said buffer, transforming the data into a standard protocol, transmitting said standard protocol to said external interface, transforming said standard protocol in the external device transmitted by said external interface into data and storing the data to said buffer.

8. The storage control system, as recited in claim 1, wherein said microcontroller is respectively connected to said data transmission submodule, said buffer, said protocol timing sequencer and said external interface, and controls a work flow of said control module according to said code in said ROM.

9. The storage control system, as recited in claim 2, wherein said microcontroller is respectively connected to said data transmission submodule, said buffer, said protocol timing sequencer and said external interface, and controls a work flow of said control module according to said code in said ROM.

10. The storage control system, as recited in claim 3, wherein said microcontroller is respectively connected to said data transmission submodule, said buffer, said protocol timing sequencer and said external interface, and controls a work flow of said control module according to said code in said ROM.

11. A storage control method, for controlling data transmission between a computer and an external device, comprising following steps:
receiving data transmitted by the computer and transmitting the data to a protocol resolution submodule by a data transmission submodule;
resolving a protocol of the data received and transmitting to a buffer by the protocol resolution submodule;
reading the data in the buffer, transforming the data into a standard protocol and transmitting the standard protocol to the external device by a protocol timing sequencer;
transforming the standard protocol transmitted by the external device into the data and storing the data to a buffer by the protocol timing sequencer; and
reading the data in the buffer, transforming the data to be recognizable to the computer, transmitting the data to the data transmission submodule by the protocol resolution submodule and further transmitting the data to the computer by the data transmission submodule.

12. The storage control method, as recited in claim 11, wherein a microcontroller is respectively connected to the data transmission submodule, the buffer and the protocol timing sequencer, the data transmission submodule, the protocol resolution module, the buffer, the protocol timing sequencer and the microcontroller form a control module, a ROM is connected to the microcontroller and the microcontroller controls a work flow of the control module according to a code of the ROM.

13. The storage control method, as recited in claim 12, further comprising a step of changing the code in the ROM according to a type of the external device to realize the data transmission between the computer and different external devices.

14. The storage control method, as recited in claim 11, wherein a USB interface is connected to the data transmission submodule and the data transmission submodule transmits the data with the computer through the USB interface.

15. The storage control method, as recited in claim 12, wherein a USB interface is connected to the data transmission submodule and the data transmission submodule transmits the data with the computer through the USB interface.

16. The storage control method, as recited in claim 13, wherein a USB interface is connected to the data transmission submodule and the data transmission submodule transmits the data with the computer through the USB interface.

17. The storage control method, as recited in claim 11, wherein the protocol resolution submodule is connected between the data transmission submodule and the buffer, an external interface is connected to the external device, and the protocol timing sequencer is connected between the buffer and the external interface and transmits and communicates with the external device through the external interface.

18. The storage control method, as recited in claim 12, wherein the protocol resolution submodule is connected between the data transmission submodule and the buffer, an external interface is connected to the external device, and the protocol timing sequencer is connected between the buffer and the external interface and transmits and communicates with the external device through the external interface.

19. The storage control method, as recited in claim 13, wherein the protocol resolution submodule is connected between the data transmission submodule and the buffer, an external interface is connected to the external device, and the protocol timing sequencer is connected between the buffer and the external interface and transmits and communicates with the external device through the external interface.

20. The storage control method, as recited in claim 14, wherein the protocol resolution submodule is connected between the data transmission submodule and the buffer, an external interface is connected to the external device, and the protocol timing sequencer is connected between the buffer and the external interface and transmits and communicates with the external device through the external interface.
